(19) United States
(12) Patent Application Publication
(10) Pub. No.: US 2025/0076076 A1
(43) Pub. Date: Mar. 6, 2025

(54) METHOD AND APPARATUS FOR PATH PLANNING AND GLOBAL LOCALIZATION IN MAPPING

(71) Applicant: NOVELTE TECHNOLOGY DEVELOPMENT LIMITED, Hong Kong (HK)

(72) Inventors: Siu Leung Thomas CHAN, Hong Kong (HK); Ho Shan POON, Hong Kong (HK); Tsun Sang CHOY, Hong Kong (HK)

(21) Appl. No.: 18/459,018

(22) Filed: Aug. 30, 2023

(51) Int. Cl. G01C 21/00; G01C 21/16; G06T 7/11; G06T 7/50; G06T 7/70

(52) U.S. Cl. CPC G01C 21/3841; G01C 21/16; G06T 7/11; G06T 7/50; G06T 7/70; G06T 2207/10024; G06T 2207/10028; G06T 2207/20081; G06T 2207/30244; G06T 2207/30252

(57) ABSTRACT

A unified mapping apparatus for path planning and global localization for a mobility device such as an autonomous or self-guiding robot or drone is provided. The unified mapping apparatus comprises a static mapping module and a dynamic mapping module. The primary function of the static mapping module is to scan the mobility device's surrounding environment static geometric for the eventual goal of global path planning. The static objects scanned and identified by the static mapping module are used for global localization. The primary function of the dynamic mapping module is to track moving objects in mobility device's surrounding environment, and predict such objects' movements. With the prediction of dynamic objects' movements, path planning can be improved substantially.

### FIELD OF THE INVENTION

The present invention generally relates to the field of mapping. More specifically the present invention relates to methods and apparatuses of path planning and localization in various mapping applications such as navigation guidance, autopilot, and robotics.

### BACKGROUND OF THE INVENTION

Mapping and navigation technology has been receiving much attention and evolving rapidly as it is one of the key components in many advanced applications such as self-driving and drones. Many of the conventional mapping and navigation technologies rely on Global Positioning System (GPS), wireless communication signal triangulation techniques, and IP address geolocation tracking.

In situations such as navigating through busy traffic and indoor navigation, real-time awareness of the immediate surroundings is required. Camera-based vision systems that combine with mapping and navigation are often deployed in such situations. Uses of radars and Light Detection and Ranging (LiDAR) sensing are increasingly popular as well. However, the LiDAR technology is still expensive with limited accuracy and questionable reliability under commercial use. However, navigation and path planning for self-driving, fully autonomous or self-guiding robots and drones remain to be a challenge as these involves not just finding the best course between a static starting point and a destination but also avoiding the moving objects, i.e., other moving vehicles and people, in the dynamically changing surroundings. As human operators are able to predict and anticipate movements of other moving objects in their surroundings and adjust their courses accordingly, there is a need in the art to develop similar predicting and anticipatory capability in self-driving, fully autonomous or self-guiding robots and drones.

### SUMMARY OF THE INVENTION

It is an objective of the present invention to address the aforementioned shortcomings in the state of the art by providing an apparatus and a method for path planning and global localization for a mobility device, which may be a self-driving vehicle, an autonomous or self-guiding robot or drone. The mobility device is equipped with at least an optical sensor, i.e., a camera, for continuously capturing videos or streams of images of its surrounding scenes.

In accordance with one aspect of the present invention, the unified mapping apparatus for path planning and global localization for a mobility device comprises a static mapping module and a dynamic mapping module.

In one embodiment, the static mapping module comprises a camera truncated signed distance function (TSDF) integration sub-module, a static semantic integration sub-module, a static Euclidean signed distance field (ESDF) integration sub-module, a static object integration sub-module, and a global pose estimation sub-module.

The camera TSDF integration sub-module is configured to: receive a depth image and a corresponding color image of a surrounding scene captured by the optical sensor of the mobility device; and generate a TSDF layer of the surrounding scene from the depth image and the color image.

The static semantic integration sub-module is configured to: receive the depth image and a corresponding static semantic image of the surrounding scene; extract the depth data from the depth image and project the extracted depth data on to the static semantic image to generate a static semantic layer; and modify the TSDF layer using the extracted depth data for cost map calculation.

The static ESDF integration sub-module is configured to: receive the modified TSDF layer; and generate a static ESDF layer comprising one or more two-dimensional (2D) map slices created based on the heights of interest in the modified TSDF layer.

The static object integration sub-module is configured to: receive the static semantic layer; cluster the semantic voxels in the static semantic layer into one or more currently observed static objects; generate a static object layer comprising the poses of the currently observed static objects; compare the currently observed static objects with preserved static objects from a static object repository to identify newly observed static objects and expired static objects, wherein the newly observed static objects are the currently observed static objects that do not match with any of the preserved static objects, and wherein the expired static objects are the preserved static objects that do not match with any of the currently observed static objects; preserve the newly observed static objects in the static object repository; and remove the expired static objects from the static object repository.

The global pose estimation sub-module is configured to compare the static object layer with the static semantic layer to estimate a global pose of the mobility device.

In one embodiment, the dynamic mapping module comprises a sensor data integration sub-module, a dynamic semantic integration sub-module, a dynamic ESDF integration sub-module, and a dynamic object integration and path prediction sub-module.

The sensor data integration sub-module is configured to: receive one or more input point clouds of the surrounding scene from one or more sensors; project the input point clouds to occupancy voxels, wherein each of non-empty occupancy voxels registers at least a velocity component; and generate an occupancy layer comprising the occupancy voxels.

The dynamic semantic integration sub-module is configured to: receive the depth image and a corresponding dynamic semantic image of the surrounding scene; extract the depth data from the depth image and project the extracted depth data on to the dynamic semantic image to generate a dynamic semantic layer; and modify the occupancy layer using the extracted depth data for cost map calculation.

The dynamic ESDF integration sub-module is configured to: receive the modified occupancy layer; and generate a dynamic ESDF layer comprising one or more 2D map slices created based on the heights of interest in the modified occupancy layer.

The dynamic object integration and path prediction sub-module is configured to: receive the dynamic semantic layer; cluster the semantic voxels in the dynamic semantic layer into one or more currently observed dynamic objects; generate a dynamic object layer comprising poses of the currently observed dynamic object; compare the currently observed dynamic objects with preserved dynamic objects from a dynamic object repository to identify newly observed dynamic objects and expired dynamic objects, wherein the newly observed dynamic objects are the currently observed dynamic objects that do not match with any of the preserved dynamic objects, and wherein the expired dynamic objects are the preserved dynamic objects that do not match with any of the currently observed dynamic objects; predict a pose for each of the newly observed dynamic objects using an Extended Kalman Filter (EKF); preserve each of the newly observed dynamic objects with its pose updated with its respective predicted pose in the dynamic object repository; remove the expired dynamic objects from the dynamic object repository; and modify the dynamic ESDF layer with the predicted poses of the newly observed dynamic objects.

In accordance with another aspect of the present invention, a navigation system for the mobility device is provided. The navigation system comprises a cost map generator configured to generate a cost map using the static ESDF layer and the dynamic ESDF layer generated by the unified mapping apparatus. The navigation system further carries out path planning using the cost map generated, and the global pose generated by the unified mapping apparatus.

In accordance with yet another aspect of the present invention, a map visualization device is provided. With an electronic display screen, the map visualization device provides the three-dimensional (3D) mesh visualization of the surrounding scene using the static object layer and the dynamic object layer generated by the unified mapping apparatus.

### BRIEF DESCRIPTION OF THE DRAWINGS:

Embodiments of the invention are described in more details hereinafter with reference to the drawings, in which:

FIG. 1 depicts a schematic diagram of an apparatus for path planning and global localization for a mobility device in accordance with one embodiment of the present invention;

FIG. 2 depicts a process flow diagram of a static object integration model of the apparatus for path planning and global localization;

FIG. 3 depicts a process flow diagram of a dynamic object integration and path prediction model of the apparatus for path planning and global localization; and

FIG. 4 depicts a process flow diagram of a global pose estimation sub-module estimating a global pose of the mobility device.

### DETAILED DESCRIPTION:

In the following description, apparatuses, systems, and methods for path planning and global localization for a mobility device and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Throughout this description, the term “mobility device” may refer to a land vehicle, a self-driving vehicle, an autonomous or self-guiding robot or drone, or any other type of propelling device that is capable of moving from one location to another, any of which may be operated indoor or outdoor. The advantages provided by the present invention, however, may be best realized when implemented in self-guiding robots and drones that operate primarily indoor.

Further, the mobility device is equipped with at least an optical sensor, i.e., a camera, for continuously capturing videos or streams of images of its surrounding scenes. Each of the captured video frames or images, which comprises at least a color image and a depth image, is processed in real-time to extract specific data from the color image and the depth image. The processes executed by the apparatuses and methods in accordance with the embodiments of the present invention then manipulate, augment, filter, compute, and/or modify the extracted data from the captured video frame or image to create layers of information, which are useful or necessary in subsequent processes. Throughout this description, the term “layer”, therefore, means a group of information related to the video frame or image captured of a surrounding scene, and which may contain one or more of image element data, pixel data, voxels, and metadata.

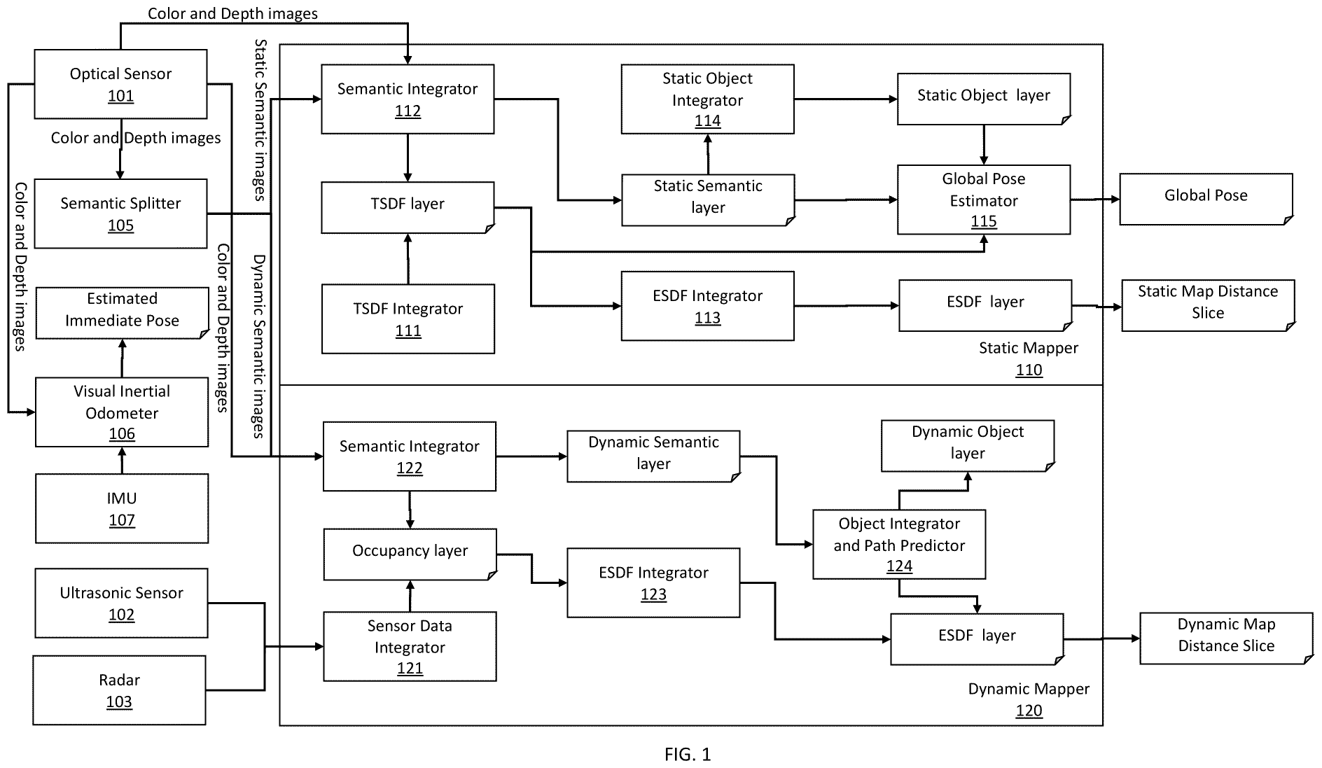

Referring to FIG. 1 for the following description. In accordance with one aspect of the present invention, the unified mapping apparatus 100 for path planning and global localization for a mobility device comprises a static mapping module 110 and a dynamic mapping module 120.

The primary function of the static mapping module 110 is to scan the mobility device's surrounding environment static geometric for the eventual goal of global path planning. The static objects scanned and identified by the static mapping module 110 are used for global localization. The static mapping module 110 has two operation modes: 1.) Scan mode, in which the static mapping module 110 continuously updates the static mapping information it generates and detects loop closures (corrections of errors in the motor encoder, camera and sensors of the mobility device); and 2.) Running mode, in which the static mapping module 110 operates to only detect loop closures for the localization of the mobility device and navigation based on the mapping information updated during the scan mode.

The primary function of the dynamic mapping module 120 is to track moving objects (labeled with semantic labels) in mobility device's surrounding environment, and predict such objects' movements. With the prediction of dynamic objects' movements, path planning can be improved substantially.

In one embodiment, the static mapping module 110 comprises a camera truncated signed distance function (TSDF) integration sub-module 111, a static semantic integration sub-module 112, a static Euclidean signed distance field (ESDF) integration sub-module 113, a static object integration sub-module 114, and a global pose estimation sub-module 115.

The camera TSDF integration sub-module 111 is configured to: receive a depth image and a corresponding color image of a surrounding scene captured by the optical sensor 101 of the mobility device; and generate a TSDF layer of the surrounding scene from the depth image and the color image.

The static semantic integration sub-module 112 is configured to: receive the depth image and a corresponding static semantic image of the surrounding scene; extract the depth data from the depth image and project the extracted depth data on to the static semantic image to generate a static semantic layer; and modify the TSDF layer using the extracted depth data for cost map calculation.

The static ESDF integration sub-module 113 is configured to: receive the modified TSDF layer; and generate a static ESDF layer comprising one or more two-dimensional (2D) map slices created based on the heights of interest in the modified TSDF layer.

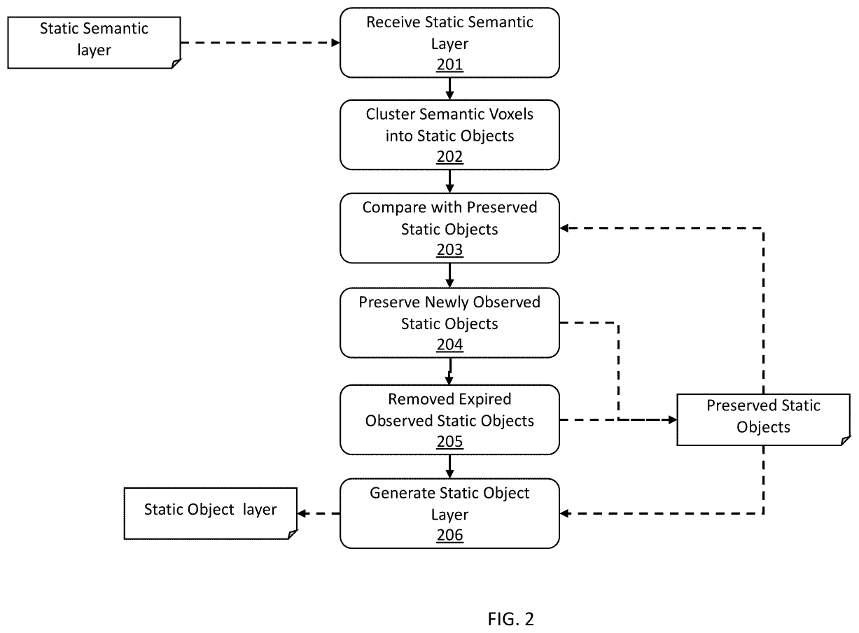

Referring to FIGS. 1 and 2 for the following description. The static object integration sub-module 114 is configured to execute the following process in generating a static object layer: (201) receiving the static semantic layer; (202) clustering the semantic voxels in the static semantic layer into one or more currently observed static objects; (203) comparing the currently observed static objects with preserved static objects from a static object repository to identify newly observed static objects and expired static objects, wherein the newly observed static objects are the currently observed static objects that do not match with any of the preserved static objects, and wherein the expired static objects are the preserved static objects that do not match with any of the currently observed static objects; (204) preserving the newly observed static objects in the static object repository; (205) removing the expired static objects from the static object repository; and (206) generating the static object layer comprising the poses of the preserved static objects in the static object repository. In one embodiment, the clustering of the semantic voxels in the static semantic layer into static objects is based on the Naive Bayes Clustering model.

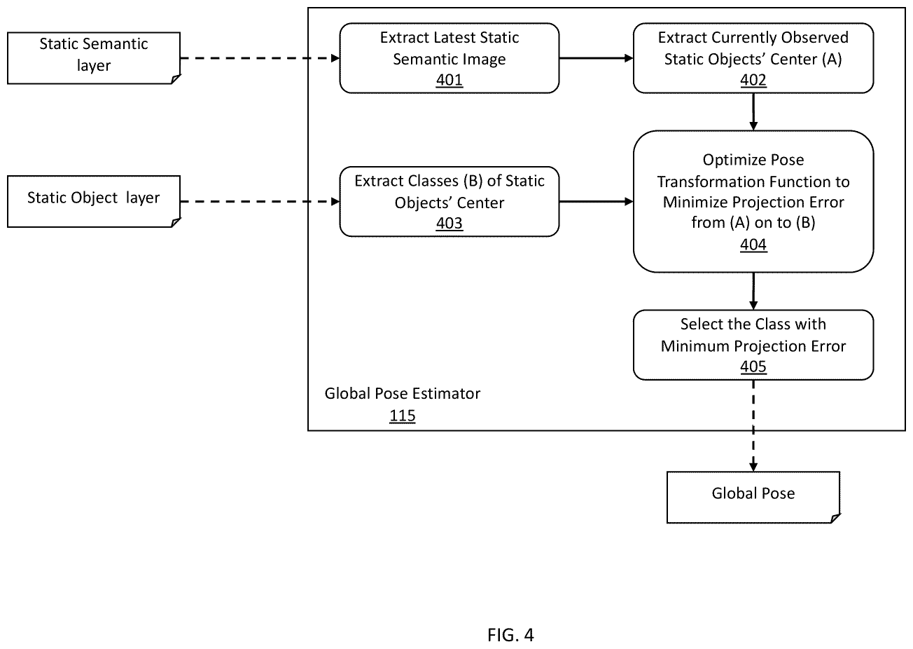

Referring to FIGS. 1 and 4 for the following description. The global pose estimation sub-module 115 is configured to execute the following process in estimating a global pose of the mobility device: (401) extracting from the input static semantic layer the latest static semantic image; (402) from the latest static semantic image, extracting the currently observed static objects' center; (403) extracting from the input static object layer one or more classes of the static objects' center; (404) optimizing a pose transformation function to minimize the projection error from the currently observed static objects' center on to the classes of the static objects' center; and (405) selecting the class with the minimum projection error and outputting the corresponding pose as the estimated global pose of the mobility device.

Referring to FIG. 1 again for the following description. In one embodiment, the dynamic mapping module 120 comprises a sensor data integration sub-module 121, a dynamic semantic integration sub-module 122, a dynamic ESDF integration sub-module 123, and a dynamic object integration and path prediction sub-module 124.

The sensor data integration sub-module 121 is configured to: receive one or more input point clouds of the surrounding scene from one or more sensors; project the input point clouds to occupancy voxels, wherein each of non-empty occupancy voxels registers at least a velocity component; and generate an occupancy layer comprising the occupancy voxels.

In one embodiment, the sensors comprise one or more of an ultrasonic sensor 102, and a radar 103. The ultrasonic sensor 102 is configured to generate an ultrasonic input point cloud of the surrounding scene. The radar 103 is configured to generate a radar input point cloud of the surrounding scene. In this case, the velocity components of the non-empty occupancy voxels are obtained from the radar's Doppler velocity measurements.

The dynamic semantic integration sub-module 122 is configured to: receive the depth image and a corresponding dynamic semantic image of the surrounding scene; extract the depth data from the depth image and project the extracted depth data on to the dynamic semantic image to generate a dynamic semantic layer; and modify the occupancy layer using the extracted depth data for cost map calculation.

The dynamic ESDF integration sub-module 123 is configured to: receive the modified occupancy layer; and generate a dynamic ESDF layer comprising one or more 2D map slices created based on the heights of interest in the modified occupancy layer.

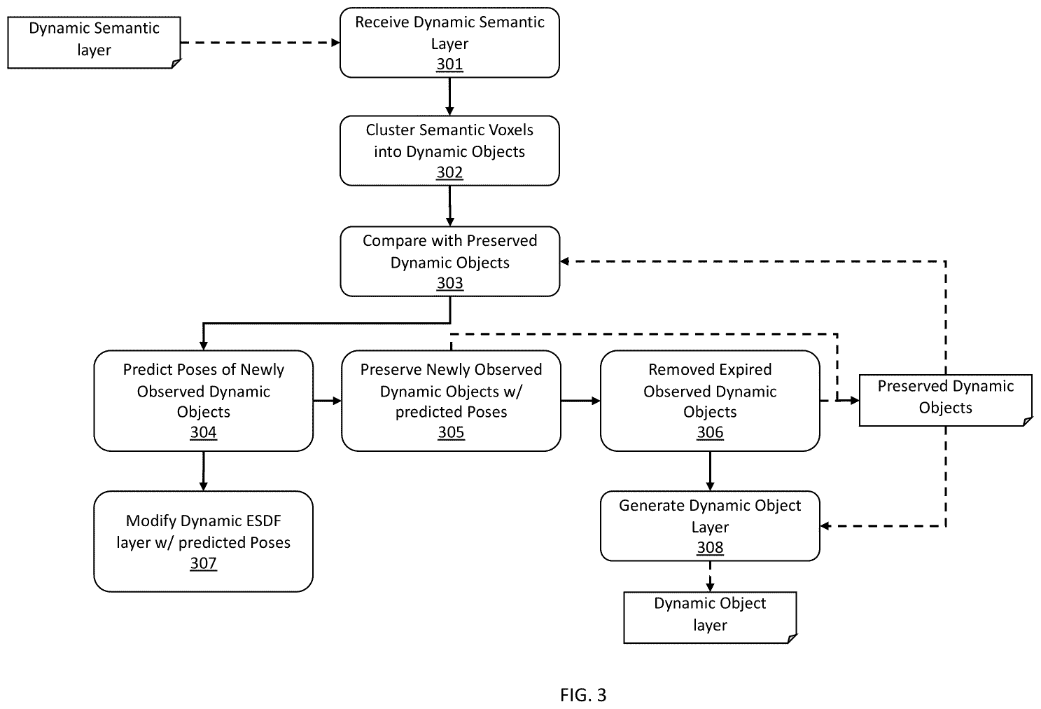

Referring to FIGS. 1 and 3 for the following description. The dynamic object integration and path prediction sub-module 124 is configured to execute the following process in generating a dynamic object layer: (301) receiving the dynamic semantic layer; (302) clustering the semantic voxels in the dynamic semantic layer into one or more currently observed dynamic objects; (303) comparing the currently observed dynamic objects with preserved dynamic objects from a dynamic object repository to identify newly observed dynamic objects and expired dynamic objects, wherein the newly observed dynamic objects are the currently observed dynamic objects that do not match with any of the preserved dynamic objects, and wherein the expired dynamic objects are the preserved dynamic objects that do not match with any of the currently observed dynamic objects; (304) predicting a pose for each of the newly observed dynamic objects using an Extended Kalman Filter (EKF); (305) preserving each of the newly observed dynamic objects with its pose updated with its respective predicted pose in the dynamic object repository; (306) removing the expired dynamic objects from the dynamic object repository; (307) modifying the dynamic ESDF layer with the predicted poses of the newly observed dynamic objects; and (308) generating a dynamic object layer comprising the poses of the preserved dynamic objects in the dynamic object repository. In one embodiment, the clustering of the semantic voxels in the dynamic semantic layer into dynamic objects is based on the Naive Bayes Clustering model.

Referring to FIG. 1 again for the following description. In accordance with another embodiment of the present invention, the unified mapping apparatus further comprises a pre-processor semantic splitting module 105 to pre-processes the color image of the surrounding scene to generate the static semantic image and the dynamic semantic image for processing by the static mapping module and the dynamic mapping module respectively. The process executed by the semantic splitting module 105 comprises: receiving the color image of the surrounding scene; classifying each pixel in the color image as a rigid or a non-rigid pixel using a machine-learning image segmentation model; and segmenting the color image into the static semantic image containing semantic information of the rigid pixels and the dynamic semantic image containing semantic information of the non-rigid pixels.

In accordance with yet another embodiment of the present invention, the unified mapping apparatus further comprises a pre-processor visual inertial odometer 106 and an inertial measurement unit (IMU) 107. The visual inertial odometer 106 operates to estimate an immediate pose of the mobility device using an angular rate and orientation of the mobility device measured by the IMU, and the color image of the surrounding scene. The estimated immediate pose of the mobility device is then used to adjust or calibrate the input point clouds received from the ultrasonic sensor and the radar by the sensor data integration sub-module 121. The estimated immediate pose is also used to adjust or calibrate the generations of the static TSDF layer by the TSDF integration sub-module 111, the static semantic layer by the static semantic integration sub-module 111, static ESDF layer by the static ESDF integration sub-module 113, the static object layer by the static object integration sub-module 114, the dynamic semantic layer by the dynamic semantic integration sub-module 122, and the dynamic ESDF layer by the dynamic ESDF integration sub-module 123.

In accordance with another aspect of the present invention, a navigation system for the mobility device is provided. The navigation system comprises a cost map generator configured to generate a cost map using the static ESDF layer and the dynamic ESDF layer generated by the unified mapping apparatus. The navigation system further carries out path planning using the cost map generated, and the global pose generated by the unified mapping apparatus.

In accordance with yet another aspect of the present invention, a map visualization device is provided. With an electronic display screen, the map visualization device provides the three-dimensional (3D) mesh visualization of the surrounding scene using the static object layer and the dynamic object layer generated by the unified mapping apparatus.

The functional units and modules of the apparatuses, systems, and methods of electronic document processing in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A unified mapping apparatus for path planning and global localization for a mobility device, the mapping apparatus comprises:
a static mapping module, being executed by at least one processor, comprising:
a camera truncated signed distance function (TSDF) integration sub-module configured to:
receive a depth image and a corresponding color image of a surrounding scene captured by an optical sensor of the mobility device; and
generate a TSDF layer of the surrounding scene from the depth image and the color image;
a static semantic integration sub-module configured to:
receive the depth image and a corresponding static semantic image of the surrounding scene;
extract depth data from the depth image and project the extracted depth data on to the static semantic image to generate a static semantic layer; and
modify the TSDF layer using the extracted depth data for cost map calculation;
a static Euclidean signed distance field (ESDF) integration sub-module configured to:
receive the modified TSDF layer; and
generate a static ESDF layer comprising one or more two-dimensional (2D) map slices created based on heights of interest in the modified TSDF layer;
a static object integration sub-module configured to:
receive the static semantic layer;
cluster semantic voxels in the static semantic layer into one or more currently observed static objects;
compare the currently observed static objects with preserved static objects from a static object repository to identify newly observed static objects and expired static objects, wherein the newly observed static objects are the currently observed static objects that do not match with any of the preserved static objects, and wherein the expired static objects are the preserved static objects that do not match with any of the currently observed static objects;
preserve the newly observed static objects in the static object repository;
remove the expired static objects from the static object repository; and
generate a static object layer comprising poses of the preserved static objects in the static object repository; and
a global pose estimation sub-module configured to compare the static object layer with the TSDF layer and the static semantic layer to estimate a global pose of the mobility device; and
a dynamic mapping module, being executed by at least one processor, comprising:
a sensor data integration sub-module configured to:
receive one or more input point clouds of the surrounding scene from one or more sensors;
project the input point clouds to occupancy voxels, wherein each of non-empty occupancy voxels registers at least a velocity component; and
generate an occupancy layer comprising the occupancy voxels;
a dynamic semantic integration sub-module configured to:
receive the depth image and a corresponding dynamic semantic image of the surrounding scene;
extract depth data from the depth image and project the extracted depth data on to the dynamic semantic image to generate a dynamic semantic layer; and
modify the occupancy layer using the extracted depth data for cost map calculation;
a dynamic ESDF integration sub-module configured to:
receive the modified occupancy layer; and
generate a dynamic ESDF layer comprising one or more 2D map slices created based on heights of interest in the modified occupancy layer; and
a dynamic object integration and path prediction sub-module configured to:
receive the dynamic semantic layer;
cluster semantic voxels in the dynamic semantic layer into one or more currently observed dynamic objects;
compare the currently observed dynamic objects with preserved dynamic objects from a dynamic object repository to identify newly observed dynamic objects and expired dynamic objects, wherein the newly observed dynamic objects are the currently observed dynamic objects that do not match with any of the preserved dynamic objects, and wherein the expired dynamic objects are the preserved dynamic objects that do not match with any of the currently observed dynamic objects;
predict a pose for each of the newly observed dynamic objects;
preserve each of the newly observed dynamic objects with its pose updated with its respective predicted pose in the dynamic object repository;
remove the expired dynamic objects from the dynamic object repository;
modify the dynamic ESDF layer with the predicted poses of the newly observed dynamic objects; and
generate a dynamic object layer comprising poses of the preserved dynamic objects in the dynamic object repository.

2. The apparatus of claim 1, further comprising:
a semantic splitting module, being executed by at least one processor, configured to:
receive the color image of the surrounding scene;
classify each pixel in the color image as a rigid or a non-rigid pixel using a machine-learning image segmentation model; and
segment the color image into the static semantic image containing semantic information of the rigid pixels and the dynamic semantic image containing semantic information of the non-rigid pixels.

3. The apparatus of claim 1, wherein the sensors comprise:
an ultrasonic sensor configured to generate an ultrasonic input point cloud of the surrounding scene; and
a radar configured to generate a radar input point cloud of the surrounding scene, wherein the radar input point cloud comprises Doppler velocity components.

4. The apparatus of claim 3,
wherein the sensors further comprise:
an inertial measurement unit configured to measure an angular rate and an orientation of the mobility device; and
a visual inertial odometer configured to estimate an immediate pose of the mobility device using the measured angular rate and the measured orientation of the mobility device, and the color image of the surrounding scene; and
wherein the ultrasonic sensor and the radar are calibrated using the estimated immediate pose of the mobility device in the generations of the ultrasonic input point cloud and the radar input point cloud respectively.

5. The apparatus of claim 1, wherein the dynamic object integration and path prediction sub-module is further configured to predict the pose for each of the newly observed dynamic objects using an Extended Kalman Filter (EKF).

6. A unified mapping method for path planning and global localization for a mobility device, the mapping method comprises:
receiving a depth image, a corresponding color image, a corresponding static semantic image, and a corresponding dynamic semantic image of a surrounding scene of the mobility device; and
generating a truncated signed distance function (TSDF) layer of the surrounding scene from the depth image and the color image;
extracting depth data from the depth image and projecting the extracted depth data on to the static semantic image to generate a static semantic layer;
modifying the TSDF layer using the extracted depth data for cost map calculation;
generating a static Euclidean signed distance field (ESDF) layer comprising one or more two-dimensional (2D) map slices created based on heights of interest in the modified TSDF layer;
clustering semantic voxels in the static semantic layer into one or more currently observed static objects;
comparing the currently observed static objects with preserved static objects from a static object repository to identify newly observed static objects and expired static objects, wherein the newly observed static objects are the currently observed static objects that do not match with any of the preserved static objects, and wherein the expired static objects are the preserved static objects that do not match with any of the currently observed static objects;
preserving the newly observed static objects in the static object repository;
removing the expired static objects from the static object repository; and
generating a static object layer comprising poses of the preserved static objects in the static object repository;
comparing the static object layer with the TSDF layer and the static semantic layer to estimate a global pose of the mobility device;
receiving one or more input point clouds of the surrounding scene from one or more sensors;
projecting the input point clouds to occupancy voxels, wherein each of non-empty occupancy voxels registers at least a velocity component;
generating an occupancy layer comprising the occupancy voxels;
projecting the extracted depth data on to the dynamic semantic image to generate a dynamic semantic layer;
modifying the occupancy layer using the extracted depth data for cost map calculation;
generating a dynamic ESDF layer comprising one or more 2D map slices created based on heights of interest in the modified occupancy layer;
clustering semantic voxels in the dynamic semantic layer into one or more currently observed dynamic objects;
comparing the currently observed dynamic objects with preserved dynamic objects from a dynamic object repository to identify newly observed dynamic objects and expired dynamic objects, wherein the newly observed dynamic objects are the currently observed dynamic objects that do not match with any of the preserved dynamic objects, and wherein the expired dynamic objects are the preserved dynamic objects that do not match with any of the currently observed dynamic objects;
predicting a pose for each of the newly observed dynamic objects;
preserving each of the newly observed dynamic objects with its pose updated with its respective predicted pose in the dynamic object repository;
removing the expired dynamic objects from the dynamic object repository;
modifying the dynamic ESDF layer with the predicted poses of the newly observed dynamic objects; and
generating a dynamic object layer comprising poses of the preserved dynamic objects in the dynamic object repository.

7. The method of claim 6, further comprising:
classifying each pixel in the color image as a rigid or a non-rigid pixel using a machine-learning image segmentation model; and
segmenting the color image into the static semantic image containing semantic information of the rigid pixels and the dynamic semantic image containing semantic information of the non-rigid pixels.

8. The method of claim 6, wherein the sensors comprise:
an ultrasonic sensor configured to generate an ultrasonic input point cloud of the surrounding scene; and
a radar configured to generate a radar input point cloud of the surrounding scene, wherein the radar input point cloud comprises Doppler velocity components.

9. The apparatus of claim 8,
wherein the sensors further comprise:
an inertial measurement unit configured to measure an angular rate and an orientation of the mobility device; and
a visual inertial odometer configured to estimate an immediate pose of the mobility device using the measured angular rate and the measured orientation of the mobility device, and the color image of the surrounding scene; and
wherein the ultrasonic sensor and the radar are calibrated using the estimated immediate pose of the mobility device in the generations of the ultrasonic input point cloud and the radar input point cloud respectively.

10. The method of claim 6, wherein the prediction of the pose for each of the newly observed dynamic objects is achieved using an Extended Kalman Filter (EKF).

11. A navigation system, comprising:
a cost map generator, being executed by at least one processor, configured to generate a cost map using the static ESDF layer and the dynamic ESDF layer generated by the unified mapping apparatus of claim 1;
wherein the navigation device is configured to execute, by at least one processor, path planning using the generated cost map and the global pose generated by the unified mapping apparatus of claim 1.

12. A map visualization device configured to execute, by at least one processor, three-dimensional (3D) mesh visualization of a surrounding scene using the static object layer and the dynamic object layer generated by the unified mapping apparatus of claim 1.
